(19) United States
(12) Patent Application Publication
(10) Pub. No.: US 2011/0120245 A1
(43) Pub. Date: May 26, 2011

(54) ROBOT ARM ASSEMBLY

(75) Inventor: BO LONG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/728,392

(22) Filed: Mar. 22, 2010

(30) Foreign Application Priority Data
Nov. 23, 2009 (CN) 200910310252.3

(51) Int. Cl. F16H 55/18; F16H 1/12

(52) U.S. Cl. 74/409; 901/28

(57) ABSTRACT

A robot arm assembly includes a first rotation shaft rotatable about a first axis, a second rotation shaft rotatable about a second axis and rotatably connected to the first rotation shaft, a pair of bevel gears coupled to the second rotation shaft for transmitting a rotary motion to the second rotation shaft, an adjusting member for adjusting the position of the first bevel gear along the second axis, and an elastic member. The pair of bevel gears includes a first bevel gear and a second bevel gear engaging with the first bevel gear. The elastic member is positioned between the distal end and the first bevel gear, and resiliently biases the first bevel gear away from the second bevel gear.

### BACKGROUND

1. Technical Field

The present disclosure generally relates to robotics, and particularly, to a robot arm assembly applied in an industrial robot.

2. Description of Related Art

A typical industrial robot commonly includes a manipulator and control equipment. The manipulator includes at least one robot arm assembly including a number of arm parts with connecting joints, wherein the rotation axes of the joints define the range of movement of the robot. The manipulator is moved by the arrangement of a drive means generating rotary motion in the respective joints. Each drive means includes an electric motor and a reduction gear. The power supply and the control of the industrial robot are provided by the control equipment.

The working range and capacity for movement of a manipulator depend on the reduction gears utilized. The reduction gear further influences the performance of the robot with respect to precision gear and/or accuracy. During the manufacture of industrial robots, reduction of total built-in backlash from the gears is desired.

A commonly used method to adjust the backlash between the gears includes calculating in advance the size of the backlash, constructing the manipulator, and measuring the actual remaining backlash. When the calculation does not correspond to the actual physical result, the manipulator must be detached and the process restarted, a time consuming and expensive procedure.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of one embodiment of a robot arm assembly.

FIG. 2 is a cross-section of the robot arm assembly taken along line II-II of FIG. 1.

### DETAILED DESCRIPTION

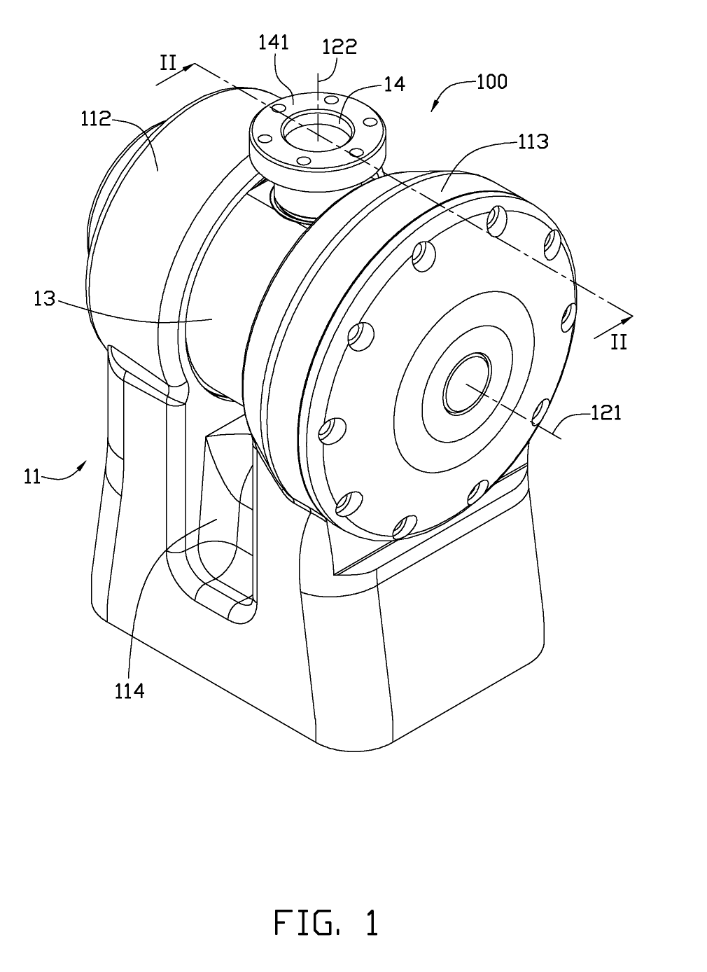

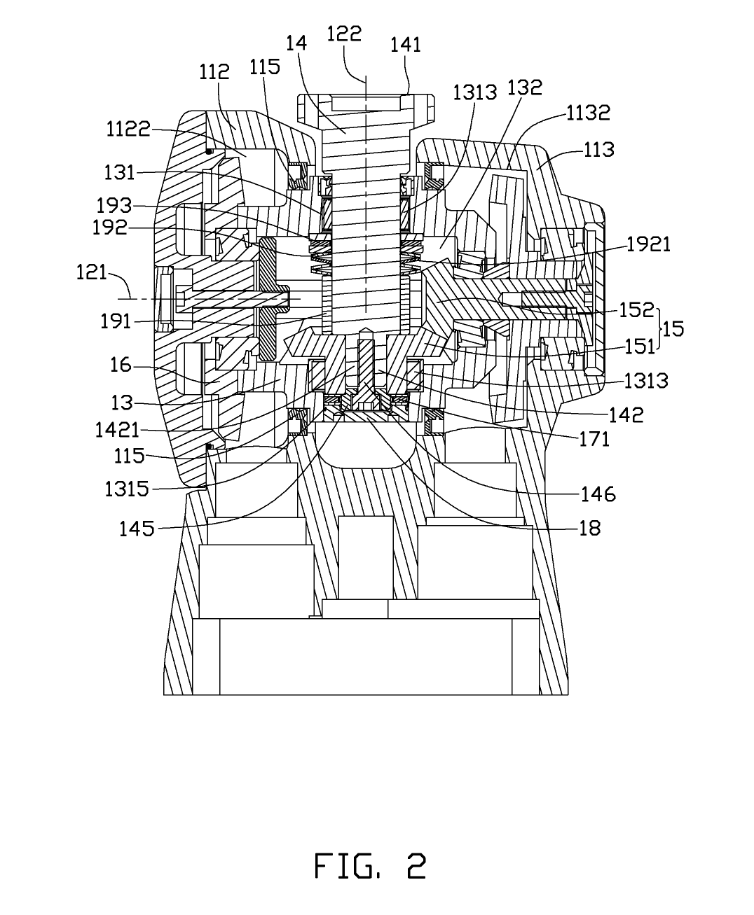

Referring to FIG. 1 and FIG. 2, an embodiment of a robot arm assembly 100 for use with a six-axis robot is shown. The robot arm 100 includes a joint 11, a first rotation shaft 13 rotatably seated in the joint 11, a second rotation shaft 14 rotatably connected to the first rotation shaft 13, and a pair of bevel gears 15 coupled to the second rotation shaft 14 for transmitting a rotary motion to the second rotation shaft 14. The first and second rotation shafts 13, 14 rotate about a first axis 121 and a second axis 122, respectively. The first axis 121 may be substantially perpendicular to the second axis 122. An actuator, such as a clamp, cutting tool or detector, can be mounted on a distal end of the second rotation shaft 14 to perform a specific task as directed.

The pair of bevel gears 15 includes a first bevel gear 151 engaging with a second bevel gear 152. The first bevel gear 151 is secured to the second rotation shaft 14, and the second bevel gear 152 is rotatably seated in the joint 11. The first bevel gear 151 may be large and the second bevel gear 152 may be small, such that a predetermined reduction ratio can be achieved when a rotary motion is transmitted from the second bevel gear 152 to the first bevel gear 151. In the illustrated embodiment, the first and second bevel gears 151, 152 are hypoid bevel gears.

The joint 11 is substantially an outer fork shaped with a first fork branch 112 and a second fork branch 113. The first and second fork branches 112, 113 cooperatively define a concave 114 therebetween to allow the second rotation shaft 14 to rotate together with the first rotation shaft 13 about the first axis 121. The first and second fork branches 112, 113 define through holes 1122 and 1132 respectively. The through hole 1122 of the first fork branch 112 may coincide with the through hole 1132 of the second branch 113.

The first rotation shaft 13 is inserted into the through holes 1122, 1132 and supported by roller bearings 115 received in the through holes 1122, 1132. One end of the first rotation shaft 13 is secured to a bevel gear 16 transmitting rotary motion to the first rotation shaft 13. The first rotation shaft 13 defines an axle hole 131 extending along the first axis 121 and an assembly hole 132 extending along the second axis 122. The axle hole 131 communicates with the assembly hole 132. The axle hole 131 is adapted to receive the second rotation shaft 14, and the assembly hole 132 is adapted to receive the second bevel gear 152.

The second rotation shaft 14 includes a distal end 141 and a connection end 142 opposite to the distal end 142. The connection end 142 is secured to the first bevel gear 151 and received in the axle hole 131. The second rotation shaft 14 is provided with a shoulder (not labeled) adjacent to the connection end 142. Opposite sides of the first bevel gear 151 along the axis are resisted by the shoulder and a resisting block 145, respectively. The connection end 142 defines a threaded hole 1421 extending along the axis. A fastener 146 passes through the resisting block 145 and is received in the threaded hole 1421. Alternatively, the first bevel gear 151 can be fixed to the second rotation shaft 14 by a tight connection such as a press fit.

Roller bearings 1313 are received in the axle 131 to support the second rotation shaft 14. A first thrust bearing 171 is movably received in the axle hole 131 and contacts the connection end 142 of the second rotation shaft 14. An adjusting member 18 contacts and adjusts the position of the thrust bearing 171 in the second axis 122. The adjusting member 18 forces the thrust bearing 171 to move the first bevel gear 151 and the second rotation shaft 14 along the second axis 122. In the illustrated embodiment, the axle hole 131 defines an internal threaded section 1315. The adjusting member 18 is substantially discoid with external threads (not labeled) on its circumference to engage with the internal threaded section 1315. Therefore, by rotating the adjusting member 18 , the position of the adjusting member 18 in the second axis 122 can be adjusted, and the first thrust bearing 171 can be moved along the second axis 122 correspondingly.

A sleeve 191, an elastic member 192, and a second thrust bearing 193 are sleeved on the second rotation shaft 14. The sleeve 191 contacts the first bevel gear 151, and the second thrust bearing 193 contacts the first rotation shaft 13. The elastic member 192 is compressed to generate a predetermined elastic force and resiliently bias the first bevel gear 151 away from the second bevel gear 152. The elastic member 192 and the adjusting member 18 cooperatively retain the first bevel gear 151 in the current position.

In the illustrated embodiment, the elastic member 192 includes a plurality of dish-shaped elastic sheets 1921. Each dish-shaped elastic sheet 1921 defines a through hole (not labeled) in the center, and a center portion extruding towards a side thereof along its axis. Two adjacent dish-shaped elastic sheets 1921 are positioned back-to-back. The number of the dish-shaped elastic sheets 192 can be adjusted according to the predetermined elastic force of the elastic member 192. The first and second thrust bearings 171, 172 may be cylindrical thrust bearings.

When adjusting a backlash between the first and second bevel gears 151, 152, operators can rotate the adjusting member 18 to move the first thrust bearing 171 to push the first bevel gear 151 along the second axis 122. Simultaneously, the elastic member 18 supplies an elastic force to push the first bevel gear 151 and the second rotation shaft 14 towards the adjusting member 18, such that the first bevel gear 151 can be moved along the second axis 122 and the backlash between the first and second bevel gears 151, 152 can be adjusted easily. In addition, the elastic member 18 can absorb impact energy on the second rotation shaft 14 and reset the rotation shaft 14 to its original position.

Finally, while the embodiment have been described and illustrated, the disclosure is not to be construed as being limited thereto. Various modifications can be made to the embodiment by those skilled in the art without departing from the true spirit and scope of the disclosure as defined by the appended claims.

What is claimed is:

1. A robot arm assembly, comprising:
a first rotation shaft rotatable about a first axis;
a second rotation shaft rotatable about a second axis and connected to the first rotation shaft, the second rotation shaft having a distal end;
a pair of bevel gears coupled to the second rotation shaft transmitting a rotary motion to the second rotation shaft, the pair of bevel gears comprising a first bevel gear and a second bevel gear engaging with the first bevel gear;
an adjusting member adjusting the position of the first bevel gear along the second axis; and
an elastic member positioned between the distal end of the second rotation shaft and the first bevel gear, and resiliently biasing the first bevel gear away from the second bevel gear.

2. The robot arm assembly of claim 1, further comprising a first thrust bearing contacting the second rotation shaft, wherein the first thrust bearing is positioned between the adjusting member and the first bevel gear and moveable along the second axis.

3. The robot arm assembly of claim 1, wherein the first rotation shaft defines an axle hole to rotatably receive the second rotation shaft.

4. The robot arm assembly of claim 3, wherein an end of the second rotation shaft away from the distal end defines an internal threaded section, and the adjusting member defines an external thread section to engage with the internal threaded section.

5. The robot arm assembly of claim 1, further comprising a sleeve sleeved on the second rotation shaft and positioned between the elastic member and the first bevel gear.

6. The robot arm assembly of claim 2, further comprising a second thrust bearing positioned between the elastic member and the distal end of the second rotation shaft.

7. The robot arm assembly of claim 1, wherein the bevel gears are hypoid bevel gears.

8. The robot arm assembly of claim 1, further comprising a resisting block secured to the second rotation shaft, wherein the second rotation shaft comprises a shoulder; opposite sides of the first bevel gear resist the resisting block and the shoulder.

9. The robot arm assembly of claim 3, wherein the first shaft further defines an assembly hole extending along the second axis communicating with the assembly hole.

10. The robot arm assembly of claim 9, wherein the second bevel gear is rotatably received in the assembly hole.

11. The robot arm assembly of claim 1, wherein the first axis is substantially perpendicular to the second axis.

12. The robot arm assembly of claim 1, wherein the elastic member comprises a plurality of dish-shaped elastic sheets, each elastic sheet defining a through hole in the center thereof and having a center portion extruding towards a side along its axis.

13. The robot arm assembly of claim 12, wherein two adjacent dish-shaped elastic sheets are positioned back-to-back.
